(19) United States
(12) Patent Application Publication
(10) Pub. No.: US 2016/0210029 A1
(43) Pub. Date: Jul. 21, 2016

(54) REMOTE DISPLAY OF A DATA WITH SITUATION-DEPENDENT CHANGE IN DATE REPRESENTATION

(71) Applicant: SIEMENS AKTIENGESELLSCHAFT, Munchen (DE)

(72) Inventor: Uwe Scheuermann, Nurnberg (DE)

(73) Assignee: SIEMENS AKTIENGESELLSCHAFT, Munchen (DE)

(21) Appl. No.: 14/996,984

(22) Filed: Jan. 15, 2016

(30) Foreign Application Priority Data
Jan. 16, 2015 (EP) 15151483.3

(51) Int. Cl. G06F 3/0484; G06F 3/0481; G06F 3/0488

(52) U.S. Cl. CPC G06F 3/04845; G06F 3/04883; G06F 3/04815; G06F 2203/04806

(57) ABSTRACT

A display unit that receives first data and second data and respective first and second metadata associated therewith, and is adapted to be operatively connected to a computing unit is disclosed. The display unit outputs the first data and the second data to a user on an output device as an image. When the display unit receives a representation command applied by the user to the output device, the display unit then decides which data the representation command relates to, and either modifies and displays that relevant data on the output device without involving the computing unit, or modifies that relevant data by conveying the representation command to the computing unit and then receiving and displaying that corresponding relevant data that is modified in accordance with the representation command from the computing unit, depending on the metadata associated with that respective first or second data.

### CROSS-REFERENCES TO RELATED APPLICATIONS

This application claims the priority of European Patent Application, Serial No. 15151483.3, filed Jan. 16, 2015, pursuant to 35 U.S.C. 119(a)-(d), the disclosure(s) of which is/are incorporated herein by reference in its entirety as if fully set forth herein.

### BACKGROUND OF THE INVENTION

The present invention is related to CNC control units, and CAD or CAM systems for controlling machine tools. In particular, the present invention is related displays that enable remote control of CNC control units and CAD or CAM systems.

A CNC control unit, or a CAD system, or a CAM system that controls a machine tools is often not connected directly to the machine tool. However, such computing systems for machine tools can display an operator interface using a protocol that is transferred to the control unit or computing system. That protocol provides a control panel for these machine tools, one transferred over an Ethernet connection for example. However, the displays of intelligent mobile devices such as notebooks or tablet PCs can also be used to display an operator interface for those machine tools.

The data displayed by the protocol can be alphanumeric data, such as rotational speeds or adjustments, positioning or other descriptions, but the data displayed can also be graphical image data. The operator interface can display different views: image sections can be changed or shifted, and different windows can be superimposed on one another, and the like, using that transferred protocol.

If one of the intelligent display units is not used as the display unit, all the computations needed by the operator interface display must be performed by the CNC computing unit. Thus, in the absence of an intelligent display unit, when the display unit receives a representation command specifying a corresponding display function that command then must be conveyed to the CNC computing unit, without exception, and the display unit then receives the first and/or second data modified in accordance with the representation command from the computing unit, and the display unit outputs the corresponding first and/or second data to the user by way of its display screen.

If an intelligent display unit is used as the display unit, the functions relating to representation commands that affect the display provided on the operator interface can be performed alternatively either by the CNC computing unit or by the processor of the intelligent display unit.

Execution of the representation commands by an intelligent display unit has the advantage that it is requires neither communication with the computing unit nor a determination of the changed data by the CNC computing unit, and the workload imposed on the computing unit is thereby reduced. The determination of the needed data changes can also be accelerated in many cases.

However, such a determination of the changed data by an intelligent display unit cannot generate any additional information. When an object presented by the screen is increased in size so that 2×2=4 or 3×3=9 pixels are now used by an image element that was previously presented as a single pixel, for example, the image information remains unchanged. However graphical data, in particular, is often determined by the computing unit using geometric data, rather than graphic data or the like. Using geometric data produces a more nearly precise representation of a given enlargement. In particular, when a representation command is conveyed to a computing unit, additional information can be made available to the user by the computing unit using such geometric data.

Similar issues arise when other representation commands are implemented. For example, if a display is reduced in size, elements that were previously arranged outside the visible image area must be represented. Also, in a rotation of the representation, some image elements that were previously obscured may become visible. Likewise, some image elements that were previously visible may now be obscured. The same applies to a representation command to shift an image section to the left or the right, or up, or down, without changing the scaling and without rotation. However, if an intelligent device is used as a control panel for controlling the machine tools, displayed elements can also be scaled to increase or reduce the size of those elements, for example.

A representation command input by a user may specify whether that representation command is to be executed locally by the display unit or conveyed to and executed by a computing unit. However, this additional input is unwieldy and error-prone. Moreover, the user must know which data can meaningfully be modified by the display unit, and which by the computing unit.

### SUMMARY OF THE INVENTION

In accordance with the present invention, the load on the computing unit executing representation commands is reduced as far as possible in a simple, automated fashion, while presenting an optimum display of image information to the user.

According to one aspect of the present invention, a method for operating a display unit that is adapted to be operatively connected with a computing unit. The display unit receives first and second data, and first and second metadata associated with the first and second data, respectively. The display unit outputs the first data and the second data as an image by way of an output device of the display unit to a user of the display unit, and the display unit receives a representation command from the user that modifies the image of this data that is output to the user by an output device.

According to another aspect of the present invention, a computer program includes machine code that is adapted to be processed by a display unit that includes a display unit. The machine code is configured to operate the display unit in accordance with the method of the invention. In a particular embodiment, the computer program is stored in a storage device in machine-readable form.

According to still another aspect of the present invention, a display unit includes an output device and is programmed with a computer program having machine code that is configured to operate a display unit in accordance with the method of the invention.

In an operating method in accordance with the invention, the display unit receives first metadata associated with the first data and second metadata associated with the second data, in addition to the first data and second data from the computing unit. The display unit then checks whether the representation command relates to the first data or to the second data.

If the representation command relates to the first data, the display unit decides whether: 1) the representation command modifies the displayed first data in accordance with the representation command without involving the computing unit, depending on the first metadata associated with the first data, or 2) conveys the representation command to the computing unit and receives first data modified by the computing unit in accordance with the representation command, and first metadata associated with the first data from the computing unit, and outputs the correspondingly modified first data by way of the output device to the user.

If the representation command relates to the second data, the display unit decides whether: 1) the representation command modifies the displayed second data in accordance with the representation command without involving the computing unit, depending on the second metadata associated with the second, or 2) conveys the representation command to the computing unit and receives second data modified by the computing unit in accordance with the representation command, and second metadata associated with the second data from the computing unit, and outputs the correspondingly modified second data by way of the output device to the user.

According to another advantageous feature of the present invention, the representation command can be a finger gesture relating to the image output, applied by the user to the display unit. If the output device is a touchscreen, as is typically the case with tablet PCs, for example, the finger gesture can be applied by the user to the touchscreen. A zoom gesture is a representation command applies a command for increasing or reducing the size of the representation of the first or second data to the display unit. Alternatively, a rotation gesture can apply a representation command for rotating a three-dimensional representation or a shift command for shifting a represented image section to the display unit.

According to another advantageous feature of the present invention, the processing of the machine code in a computer program by the display unit causes the display unit to perform an operating method according to the invention. In particular, the computer program can be stored in a storage device in machine-readable form, for example in electronic form.

According to another advantageous feature of the present invention, the display unit can be connected to a computing unit and s programmed with a computer program in accordance with the invention.

According to another advantageous feature of the present invention, the display unit can be a tablet PC, a notebook or a smartphone.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a block diagram of a display unit in accordance with the invention;

FIG. 2 is a flowchart of a method in accordance with the invention; and

FIG. 3 is a schematic diagram of a display for the unit shown in FIG. 1.

### DETAILED DESCRIPTION OF A PREFERRED EMBODIMENT

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

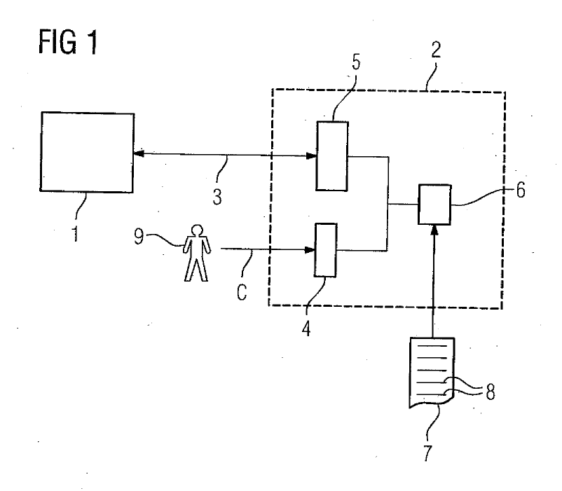

In FIG. 1, a computing unit 1 communicates with a display unit 2. For this purpose the computing unit 1 is connected to the display unit 2 by way of a data connection 3.

The computing unit 1 can for example be a numeric controller or a CAM system or a CAD system. The display unit 2 is an intelligent display unit. In addition to an output device 4 it comprises at least one processor 5 and one storage device 6. The display unit 2 can for example be embodied as a tablet PC, as a notebook or as a smartphone. The data connection 3 can for example be based on Ethernet technology. The output device 4 can for example be embodied as a screen, in particular as a touchscreen.

A computer program 7 is stored in the storage device 6 in machine-readable form, for example in electronic form. The computer program 7 comprises machine code 8 which can be executed by the display unit 2. The display unit 2 is programmed with the computer program 7. The processing of the machine code 8 by the display unit 2 causes the display unit 2 to perform an operating method which will be described in detail in the following with reference to the further figures.

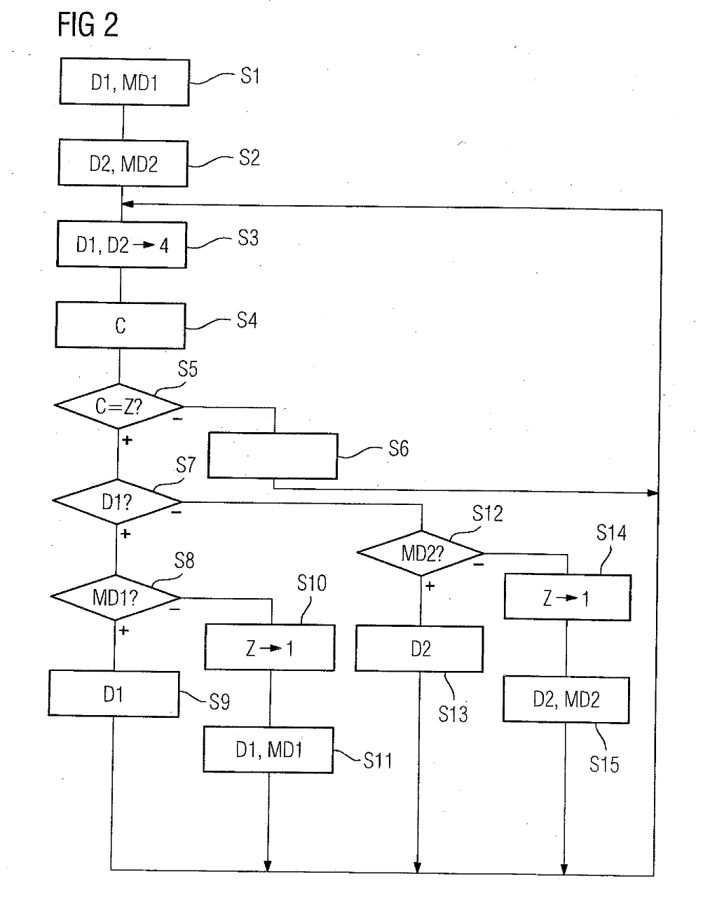

According to FIG. 2, in a step S1 the display unit 2 receives first data D1. The display unit 2 furthermore receives first metadata MD1 in step S1. The first metadata MD1 is associated with the first data D1. In a step S2 the display unit 2 furthermore receives second data D2. The display unit 2 furthermore receives second metadata MD2 in step S2. The second metadata MD2 is associated with the second data D2. The receipt of the first data D1, the first metadata MD1, the second data D2 and the second metadata MD2 can also be combined in a single step. Regardless of whether the one or the other approach is adopted, the respective data D1, D2 is however as a general rule transferred from top to bottom with reference to the illustration.

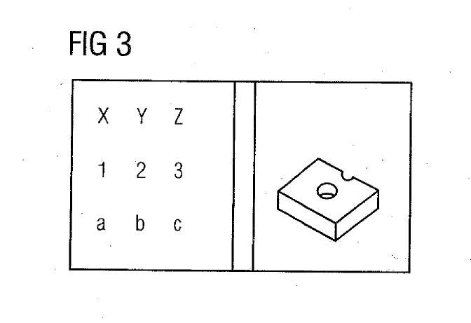

In a step S3 the display unit 2 outputs the first data and the second data D1, D2 as an image 4 to a user 9 by way of the output device 4. FIG. 3 shows—purely by way of example—a display as it is output to the user 9 by way of the output device 4. According to FIG. 3, the first data D1 is output to the user 9 in the left-hand part of the output device 4. The data D1 in question can (for example) be alphanumeric data. The second data D2 is output to the user 9 in the right-hand part of the output device 4. The data D2 in question can (for example) be graphical data, for example a representation of a workpiece.

In a step S4 the display unit 2 receives a command C from the user 9. In a step S5 the display unit 2 checks whether the command C in question is a representation command Z. If this is not the case, the display unit 2 goes to a step S6 in which it performs an action. The action is—naturally—dependent on the command C. The display unit 2 returns to step S3.

If the command C is a representation command Z, then the display unit 2 checks in a step S7 whether the representation command Z relates to the first data D1.

If the representation command Z relates to the first data D1, the display unit 2 goes to a step S8. In step S8 the display unit 2 decides whether or not it should process the displayed first data D1 directly using the first metadata MD1. The display unit 2 goes to a step S9, if it should process the first data D1 directly. In step S9 the display unit 2 modifies the first data D1. The display unit 2 performs step S9 without involving the computing unit 1. The display unit 2 then returns to step S3.

When step S3 is executed again, the display unit 2 outputs the correspondingly modified first data D1 by way of the output device 4 to the user 9. On the other hand, the display unit 2 goes to a step S10, if the display unit 2 should not process the first data Di directly. In step S10 the display unit 2 conveys the representation command Z to the computing unit 1. The computing unit 1 computes modified first data D1 using the conveyed representation command Z. In step S11 the display unit 2 receives the correspondingly modified first data D1 from the computing unit 1. In step S11 the display unit 2 furthermore—in analogous fashion to step S1—receives the associated first metadata MD1 from the computing unit 1. The display unit 2 then returns to step S3.

If the representation command Z relates to the second data D2, the display unit 2 goes to a step S12. In step S12 the display unit 2 decides whether or not it should process the displayed second data D2 directly using the second metadata MD2. If it should process the second data D2 directly, the display unit 2 goes to a step S13. In step S13 the display unit 2 modifies the second data D2. The display unit 2 performs the S13 without involving the computing unit 1. The display unit 2 then returns to step S3. When step S3 is executed again, the display unit 2 outputs the correspondingly modified second data D2 by way of the output device 4 to the user 9.

If it is determined that the display unit 2 should not process the second data D2 directly, on the other hand, the display unit 2 goes to a step S14. In step S14 the display unit 2 conveys the representation command Z to the computing unit 1. The computing unit 1 provides modified second data D2 using the conveyed representation command Z. In a step S15 the display unit 2 receives the correspondingly modified second data D2 from the computing unit 1. Furthermore, in a manner analogous to step S2, the display unit 2 receives the associated second metadata MD2 from the computing unit 1 in step 15. The display unit 2 then returns to step S3.

The representation command Z can for example be a zoom command, a command for increasing or for reducing the size of the representation of the first or second data D1, D2. Alternatively, however, it is possible that the representation command Z is a rotation command for rotating an image of a three-dimensional representation. It is also possible that the representation command Z is a shift command for shifting a section of the representation shown in an image.

A command C can also—at least in some cases—be given to the display unit 2 by means of finger gestures applied by the user 9, relating to the image that is output, as are the representation commands Z. For example, the output device 4 can be a touchscreen, as shown in FIG. 1. In this case, commands C can be given by means of corresponding finger gestures applied on the screen 4. This is indicated in FIG. 1 by commands C being given by way of the screen 4.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for operating a display unit, said display unit receiving first data and second data and being operatively connected to a computing unit, said display unit using an output device of the display unit to display the first data and the second data to a user on the display unit as an image, said display unit receiving a representation command from the user that effects a modification of the data output by the output device to the user, comprising:
checking whether the representation command received by display unit relates to the first data or to the second data;
when the representation command received by display unit relates to the first data then, using the first metadata associated with the first data, determining whether the representation command received by display unit and the first metadata associated with the first data: 1) modifies the first data without involving the computing unit, so that the display unit modifies the first data in accordance with the representation command and outputs the correspondingly modified first data to the user using the output device, without using the computing unit to modify the first data, or 2) conveys the representation command to the computing unit and receives first data from the computing unit that is modified in accordance with the representation command received by display unit, and outputs the correspondingly modified first data to the user by way of the output device using the computing unit, depending on the first metadata associated with the first data; and
when the representation command received by display unit relates to the second data then, using the second metadata associated with the second data, determining whether the representation command received by display unit and the second metadata associated with the second data: 1) modifies the second data without involving the computing unit, so that the display unit modifies the second data in accordance with the representation command and outputs the correspondingly modified second data to the user using the output device without using the computing unit, or 2) conveys the representation command to the computing unit and receives second data from the computing unit that is modified in accordance with the representation command received by display unit, and outputs the correspondingly modified second data to the user by way of the output device using the computing unit, depending on the second metadata associated with the second data.

2. The operating method of claim 1, wherein the representation command is applied by the user to the image that is output to the user on the display unit, as a finger gesture.

3. The operating method of claim 2, wherein the representation command is a zoom command for increasing or for reducing the size of a representation of the first or second data that is output. to the user by the display unit.

4. The operating method of claim 2, wherein the representation command is a rotation command for rotating a three-dimensional representation of the first or second data that is output to the user by the display unit.

5. The operating method of claim 2, wherein the representation command is a shift command for shifting a section of an image representing the first or second data that is output to the user by the display unit.

6. A computer program having machine code adapted to be processed by a display unit, said display unit receiving first data and second data and having an output device adapted to display first and second data to a user as an image, said computer program comprising:
machine code configured to check whether the representation command received by display unit relates to the first data or to the second data; and
when the representation command received by display unit relates to the first data, then using the first metadata associated with the first data to determine whether the representation command received by display unit and the first metadata associated with the first data, said computer program comprising machine code configured to 1) modify the first data without involving the computing unit, so that the display unit modifies the first data in accordance with the representation command and outputs the correspondingly modified first data to the user using the output device, without using the computing unit to modify the first data, or 2) convey the representation command to the computing unit and receive first data from the computing unit that is modified in accordance with the representation command received by display unit, and output the correspondingly modified first data to the user by way of the output device using the computing unit, depending on the first metadata associated with the first data; and
when the representation command received by display unit relates to the second data, then using the second metadata associated with the second data to determine whether the representation command received by display unit and the second metadata associated with the second data, said computer program comprising machine code configured to 1) modify the second data without involving the computing unit, so that the display unit modifies the second data in accordance with the representation command and outputs the correspondingly modified second data to the user using the output device without using the computing unit, or 2) convey the representation command to the computing unit and receive second data from the computing unit that is modified in accordance with the representation command received by display unit, and output the correspondingly modified second data to the user using the output device using the computing unit, depending on the second metadata associated with the second data.

7. The computer program of claim 6 wherein the program is stored in a storage device in machine-readable form.

8. A display unit adapted to be operatively connected to a computing unit, said display unit receiving first and second data, said display unit comprising:
an output device, said display unit using the output device to display the first and second data received by the display device to a user on the output device as an image; and
a stored computer program having machine code adapted to be processed by the display unit, having:
machine code configured to check whether the representation command received by display unit relates to the first data or to the second data; and
when the representation command received by display unit relates to the first data, then using the first metadata associated with the first data to determine whether the representation command received by display unit and the first metadata associated with the first data, said computer program comprising machine code configured to 1) modify the first data without involving the computing unit, so that the display unit modifies the first data in accordance with the representation command and outputs the correspondingly modified first data to the user using the output device, without using the computing unit to modify the first data, or 2) convey the representation command to the computing unit and receive first data from the computing unit that is modified in accordance with the representation command received by display unit, and output the correspondingly modified first data to the user by way of the output device using the computing unit, depending on the first metadata associated with the first data; and
when the representation command received by display unit relates to the second data, then using the second metadata associated with the second data to determine whether the representation command received by display unit and the second metadata associated with the second data, said computer program comprising machine code configured to 1) modify the second data without involving the computing unit, so that the display unit modifies the second data in accordance with the representation command and outputs the correspondingly modified second data to the user using the output device without using the computing unit, or 2) convey the representation command to the computing unit and receive second data from the computing unit that is modified in accordance with the representation command received by display unit, and output the correspondingly modified second data to the user using the output device using the computing unit, depending on the second metadata associated with the second data.

9. The display unit of claim 8 wherein, the display unit is one member of a group comprising a tablet PC, a notebook and a smartphone.
